(19) United States
(12) Patent Application Publication
(10) Pub. No.: US 2019/0333126 A1
(43) Pub. Date: Oct. 31, 2019

(54) Process and system in which the user can save and compare two or more items between a single or multiple internet marketplaces

(71) Applicant: Sharon M. Moore, San Antonio, OH (US)

(72) Inventor: Sharon M. Moore, San Antonio, OH (US)

(21) Appl. No.: 16/435,543

(22) Filed: Jun. 9, 2019

Related U.S. Application Data
(63) Continuation-in-part of application No. 15/479,376, filed on Apr. 5, 2017.

(51) Int. Cl. G06Q 30/06

(52) U.S. Cl. CPC G06Q 30/0623; G06Q 30/0641; G06Q 30/0633

(57) ABSTRACT

This current invention is a system and application that is aimed to assist in making decisions when confronted with a large amount of options. The initial embodiment of the application is targeted towards simplifying decision making for online shopping. The process will consist of searching for items amongst online shops, adding possible items into a cart, then the app will present two or more of the items at a time and the user will determine the preferred items by eliminating or saving to a wish list the least or most preferred items. Every possible combination of items in the cart will be presented. The least desired products eliminated, resulting in the users preferred products. The application can be modified to address other situations in which many choices are possible and often difficult to distinguish which options are superior.

### CROSS-REFERENCES TO RELATED APPLICATIONS (IF ANY)

The Application is a Continuation-in-part to application Ser. No. 15/479,376 filed on Apr. 5, 2017.

### BACKGROUND

### 1. Field of the Invention

The present invention relates to a process to record and optimize efficiency of comparing and selecting products through online marketplaces.

### 2. Description of Prior Art

Online shopping has become a normal activity, with some people using it as a primary means of shopping. Many market places include features to compare multiple products to assist in making a purchasing decision. For example, a customer could click a box beside 3 products and hit a “compare” option; then, the user would be taken to a page which shows each product's specifications side-by-side.

There is still room for improvement in the art.

### SUMMARY OF THE INVENTION

The current invention is a system and application in which the user can compare and decide between purchasing options on a single internet shopping venue or between multiple internet shops, with each decision being unique, i.e., a choice between two or more items, the removal of the least desirable of the products by adding it to a Wish list or eliminating it altogether, and repeat the process until all shopping cart products have been compared; saved or eliminated; and only the most desired products remains in the cart.

The system, in the preferred embodiment, would work like a computer application, smartphone application, or a website application.

The process would be that a user would register and login. They would do their shopping search through the app and add their selections to a comparison list by clicking the ADD TO COMPARE option. The ADD TO COMPARE function enables the shopper to store products in an electronic shopping category, cart, or basket. Filters can be established to select for or against certain characteristics. Alternatively, users would use the process via search engines or within specific shopping venue cart(s) as add-ons/extensions.

Once the comparison list, which can be a cart, is populated, the user would use the Comparison Interface. A cart can also be referred to as a basket. Two or more of the possible item selections will be presented. The user would determine the favored item and then eliminate the other items by using the “x”, or save it in a Wish list for later comparisons. Once the user has made this decision, another item from the user's COMPARE list (cart) will be presented, offering the user the next multi-choice decision. Side-by-side comparisons of multiple choices continue until the user has selected among all desired choices. The most preferred items will remain in the cart for comparison with the next choice, making a purchase, or saving for later use in a wish list to make additional comparisons. The user can choose to purchase any item at any point in the COMPARE model run. The user will have an option to use the Eliminate (“x) tool to independently remove items from the cart. The user will also have an option to move an item from the comparison interface to a wish list. The system will track data regarding how choices are made, and patterns of how characteristics are selected, for or against. As the system tracks how the choices are made it can organize the items by predicted preference, before going through the comparison process.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 a system overview chart;

FIG. 3 shows a cell phone screen; and

FIG. 4 shows a sample comparison screen.

### DESCRIPTION OF THE PREFERRED EMBODIMENT

There are a number of significant design features and improvements incorporated within the invention.

The current invention is a system and application that would allow consumers to compare items, products and/or services head-to-head, two or more items at a time, while shopping online.

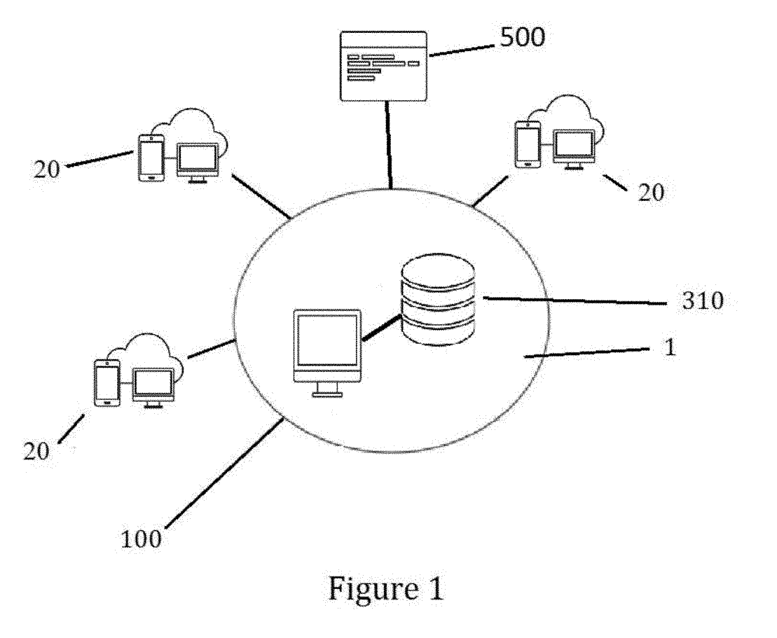

FIG. 1 displays the preferred embodiment of the system architecture 1 accessed through an Internet, Intranet and/or Wireless network 500. However, the system could be implemented on a device-to-device or client/server architecture as well. The system 1 is set to run on a computing device 20 or a website 500.

In FIG. 1, the system 1 is accessed from a user's computing device 20 through a web browser over HTTP and/or HTTPS protocols to a website 500 or wireless network or cell phone to cell phone connection. A computing device 20, such as a cell phone, that can access the system 1 must have some version of a CPU, CPU memory, local hard disk, 5 keyboard/keypad/input and display unit. The computing device 20 can be any desktop, laptop, tablet, smart phone or general-purpose computing device with an appropriate amount of memory suitable for this purpose and an active connection to the Internet or a wireless network. Computing devices like this are well known in the art and are not pertinent to the invention.

The system 1, data and processing code can reside in the non-transitory memory 310 of the one or more computing devices. The system 1 in the preferred embodiment would be written to act like a computer application, smart phone application (app) or website application where the different apps can communicate with each. The system 1 may work with a central server as shown in FIG. 1, or in parallel which each computing device 20, or smartphone communicating with others within the system 1. The system 1 can also work as a website application.

The system 1, data and processing code can reside in the non-transitory memory 310 of the one or more computing devices. The system 1 could have a touch screen 100 or normal screen to allow a user to swipe the screen when making choices and decisions.

This current invention is a system 1 that can work as a computer application (app) that is aimed to simplify decision making when a large amount of options is possible, such as in an online marketplace. It is a system and computer application (app) in which the user adds items from a single or many different web sites, then the items are presented to the user two or more at a time in a decision model, and the user chooses the preferred items by either eliminating or adding items to the list by selecting the most desirable or eliminating the least desirable items. The choices and selection are stored in a database memory 310.

After all possible pairings have been presented, and the user has either eliminated or saved to a wish list the least desirable product between the two or more product choices, what will remain at the end of the model run is the most desired products. The system 1 is a shopping decision model (shopping tool) which enables the consumer to pare down a fully loaded-up shopping cart to the most desired products.

The system's shopping cart can be filled from a single to many on-line shopping venues. As the consumer discovers items of interest they simply add them to the system's database by clicking an ADD TO COMPARE icon. Once the shopping cart is filled with the consumer's desired products, the consumer then clicks the COMPARE icon. During the model run, the system 1 presents every item in the cart in a decision layout.

For reference, the system 1 can save and store all the information about the items in the wish list including their identification information, website and internet address. This allows the user quick reference to the items looked at as well as a reference database.

The user compares all the product information for the listed items; eliminates, or adds to wish list the least preferred item or items, then the model delivers the next of set choices. The model will run until all available choices are presented. To obtain the most desired products the model must be fully run until all selected items have been presented and only the most desired products remains in the shopping cart.

In this manner the shopper trims down their cart to the most desired products most-suited to meet the consumers' needs and price point.

It is recommended to the User to run the model until all possible items have been presented. As an option, the user can choose to purchase any item at any point in the model run.

THE SYSTEM 1 allows the user to have multiple shopping carts. The user can name their shopping cart and save it for later reference (such as “TV” or “WINTER JACKET”, or even have a “MISCELLANEOUS” cart, composed of the shopper's entire online wish list). The shopper's carts can be filled and refilled multiple times, deleted, recreated, depending on the shopping experience of the day.”

An example shopping experience is as follows:

The shopping agenda for the day is to find the perfect rug at the right price to be used under the family dining room table. The system 1 may have an option where the shopper creates a system cart and then uses major search engines and visits rug specific online stores and saves interesting rugs by clicking the ADD TO COMPARE tool. The system 1 allows the user to choose as many rugs as desired in this manner. Once the user has selected all the rugs of interest, the user clicks the COMPARE icon and the model begins to run. Two or more rugs are presented in a side-by-side comparison. The user then either eliminates the least desired rugs by clicking the “x” or saves it to a wish list. Then another rug(s) from the user's selections are presented along with the retained rug(s). The user eliminates or saves the least desirable rug between the choices presented. The COMPARE model continues to run, repeating the process, until all the rugs are either eliminated or saved to a Wish list except the most desirable rug(s).

To obtain the user's most preferred items, the user must fully run the model until all choices are presented, the user chooses between the presented items and eliminates the least preferred item or items from the cart, leaving the favored item in the shopping cart. As the model runs, the user must always eliminate their least preferred product(s) by clicking the “x” or “Add to Wish list”.

Sometimes a user may add an item to the cart based upon one aspect of the product criteria, such as style, color, or fabric. But, in the preferred embodiment, once they run the model, and thoroughly study all the product data, they realize adding the item to the cart was a mistake because other learned aspects of the product make it a non-purchase. For this reason, the system 1 allows the user to eliminate an item altogether. The model adjusts for the removal of the item and then proceeds with the next decision. If the user decides at a later time to add an eliminated item back into the cart, or add new items into the cart, then the model will adjust for those added decisions. The user reruns the model until all possible choices have been presented and the final product(s) remains in the comparison screen.

Finally, the system 1 uses links from online shopping venues and sometimes these links get broken or the product is no longer available. Therefore, items setting in the cart over a long period may no longer be available at the stored link.

Filters would be an options screen that allows users to set up search parameters for the products. The cart holds all of the users saved selections in a database. This can be cleared at any time. More than one cart can be created by the system 1.

As stated above, the system 1 can be used for services as well as products and goods. The system 1 allows the ability to compare service providers . . . one to another. It uses the same process but not a buying option, but rather a services comparison option.

### Operation

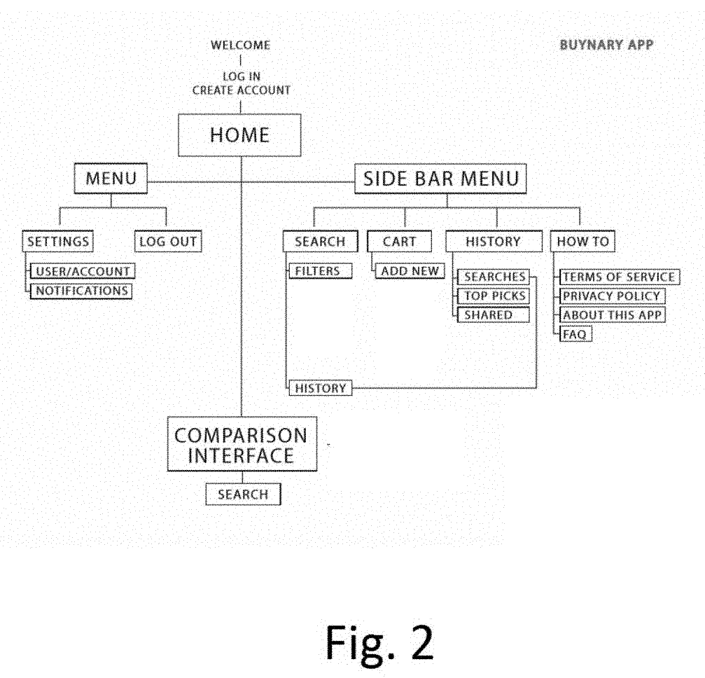

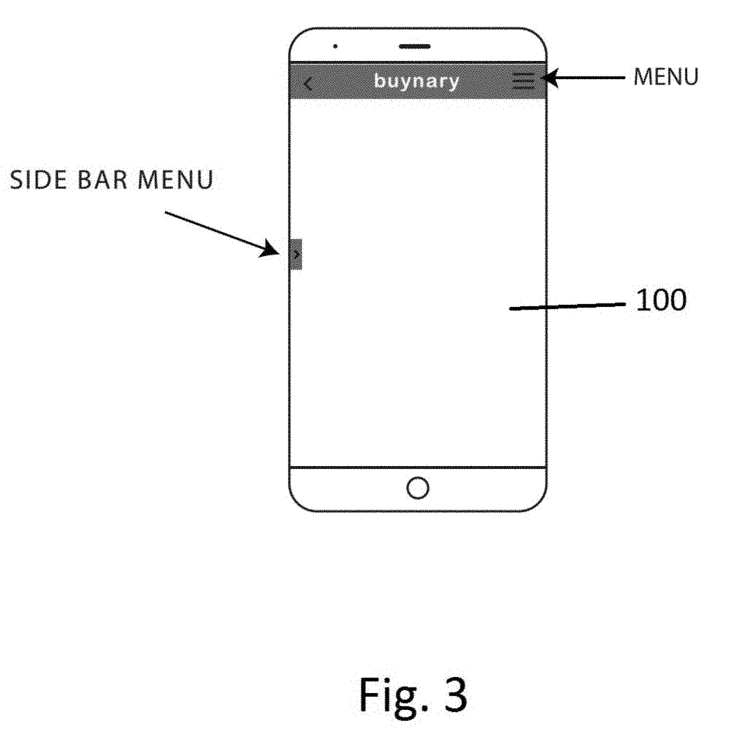

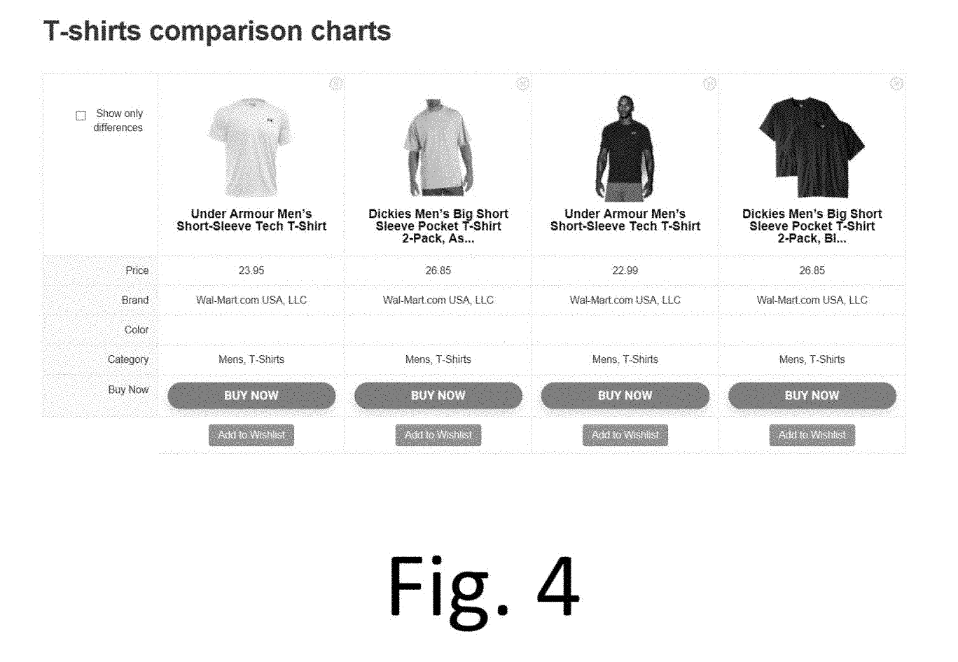

The system 1 setup is shown in the flowchart of FIG. 2. FIG. 3 shows a smart phone with a touch point screen 100 and the menu and side menu. The user would log on or create an account on the system 1. After logging in, in the preferred embodiment, there will be a HOME screen. From the HOME screen, the user can access the MENU, COMPARISON INTERFACE and the SIDE BAR MENU options. The Menu has the SETTINGS and to LOGOUT functions. In Settings, the user can access Notifications and User/Account areas. User/Account allows the user to view and edit their personal information. The LOGOUT function will allow the user to log out. The COMPARE Interface will present the options from a cart as shown in FIG. 4. The user will select the preferred choices, and new items will be presented. This choice and the information about the choice will be stored in memory 310. When all possible items from a Cart have been presented, and the least desirable products removed with each decision, only the most desired products will appear. From the HOME screen, the user can access the SIDE BAR MENU. The Side Bar Menu links to SEARCH, CART, HISTORY, and HOW TO options.

Within SEARCH, the user will look for items that match the general criteria of the product they wish to purchase. The user can view the search HISTORY and also modify FILTERS. FILTERS will present options for search parameters that may be used on all searches or on individual searches.

Within CART, the user can click the ADD TO COMPARE icon, to add a search result into a general or specified cart separated by category. The user can use the REMOVE (“x”) function to eliminate items, or can move an item to ELIMINATED ITEMS folder. The user can bring back the item by clicking the ADD TO COMPARE function to move an item from Eliminated Items to the cart it had previously been in. Within the HISTORY, the user can view prior SEARCHES, TOP PICKS, and SHARED items. Within HOW TO, the user can select to view TERMS OF SERVICE, PRIVACY POLICY, ABOUT THIS APP, and FAQ informational pages and functions.

The user can search for items, can add them to a list or a cart, then select preferences between all possible head-to-head comparisons of items in the cart. Once complete, only the most desirable products will remain in the shopping cart. Items can be added or removed from the cart and the operation may be repeated. Multiple carts may be created for different groupings, such as “umbrellas”, “cameras”, or “miscellaneous”. The system 1 can be used for other decision-making processes, such as where should the family take a vacation; what medicine best fits a patient's need; surveys; photo contests; resume processing to select the most qualified candidate; establishing priorities; determining how to best allocate the family budget, etc.

### Advantages

The system 1 enables the consumer to turn down the information firehose and focus on only one decision at a time. It also enables the shopper to easily track products between multiple internet sites, minimizing the time and frustration of moving back and forth between venues.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
placing a plurality of choices into an electric shopping cart;
initiating a comparison decision compare option by:
making a selection from a number of item choices;
comparing one choice against another item choices;
choosing between the items and eliminating the least desired products, or
enabling the user to make a purchase decision at any point in the process;
enabling the user to ‘Eliminate’ items individually from the model run;
enabling the user to ‘Save to Wish list’ items individually from the shopping cart

2. A system according to claim 1 where the choices have web links associated with them.

3. A system according to claim 1 where the choices are put into an electronic shopping cart.

4. A system according to claim 1 having the shopping cart filed with choices from a single or a plurality of online shopping venues.

5. A system according to claim 1 that is run as an application on one or more of a set of a smart phone, computer, desktop, laptop, tablet, smart phone or other general purpose computing device.

6. A system according to claim 1 that is run on a website.

7. A system according to claim 1 where the choices are stored in a database.

8. A system according to claim 1 where a choice not chosen is moved to an elimination file, or save for later file (wish list).

9. A system according to claim 8 further comprising allow a choice not chosen may be moved to the elimination file.

10. A system according to claim 1 further comprising having filters that allows the setting up of search parameters.

11. A system comprising;
placing a plurality of choices into a database;
making a selection from a number of choices;
comparing the choice against other choices;
choosing between the items;
repeating until all of the choices have been presented in the comparison model;
eliminating the least desired products, or;
saving to a wish list the least desired products;
obtaining the most desired products in the shopping cart.

12. A system according to claim 11 where the choices have web links associated with them.

13. A system according to claim 11 that is run as an application on a smart phone.

14. A system according to claim 11 that is run on one or more of a set of computer, desktop, laptop, tablet, smart phone or computing device.

15. A system according to claim 11 that may be ran as an extension on a website.

16. A system according to claim 11 further comprising removing the choice not chosen.

17. A system according to claim 11 further comprising repeating the steps until a single choice is left.

18. A system comprising;
having a system that resides in the non-transitory memory of a computing device;
placing a plurality of choices into an electric shopping cart;
initiating a decision compare option by:
making a selection from a number of paired choices;
comparing choice against another choices;
choosing between the choices by selecting the most desired products and the other products automatically falls out;
enabling the user to make a purchase decision at any point in the process;
enabling the user to ‘Eliminate’ items individually from the shopping cart; model run;
enabling the user to ‘Save to Wish list’ items individually from the shopping cart

19. A system according to claim 18 where the choices have web links associated with them.

20. A system according to claim 18 having the shopping cart filed with choices from a single or a plurality of online shopping venues.
